(19) United States
(12) Patent Application Publication
(10) Pub. No.: US 2007/0245488 A1
(43) Pub. Date: Oct. 25, 2007

(54) Maneuverable Device for Transporting Loads Over a Surface

(76) Inventors: Dov Zimbalista, Kiryat Ono (IL); Ran Zimbalista, Moshav Avigdor (IL)

Correspondence Address: PEARL COHEN ZEDEK LATZER, LLP, 1500 BROADWAY 12TH FLOOR, NEW YORK, NY, 10036, US

(21) Appl. No.: 10/577,837

(22) PCT Filed: Oct. 26, 2004
(86) PCT No.: PCT/IL04/00973

§ 371 Date: Jun. 5, 2007

(30) Foreign Application Priority Data
Oct. 30, 2003 (IL) 158683

(51) Int. Cl. A61G 1/02

(52) U.S. Cl. 5/86.1

(57) ABSTRACT

A maneuverable device for transporting a load over a surface, which finds particular application in a hospital bed for the transportation of patients and in a wheelchair for transporting patients or passengers in an air terminal, for example. The device has a platform for supporting a load to be transported mounted on a base comprising a plurality of castors. One or more one auxiliary wheels are mounted for rotation about at least one fixed axis with respect to said base, and a power unit configured for providing motive power to the auxiliary wheels is provided. A driving unit is provided for steering the device, the driving unit operating independently of the auxiliary wheels.

### FIELD OF THE INVENTION

This invention relates to a transportation device. More particularly the present invention relates to maneuverable devices that can be selectively moved manually or under power, and especially adapted for use as a patient trolley or hospital bed.

### BACKGROUND OF THE INVENTION

Wheeled hospital beds are a major form of transportation for patients in a hospital. Such beds are used for the long range transportation of patients from one location of a hospital to a different location, for example, and also for short-range maneuvering of the bed into a parking position within a room. Accordingly, the beds are typically designed with castors in a rectangular array approximately underlying a patient-supporting platform to enable the bed to be maneuvered in any direction. The castors can generally be fixed in one of three modes: neutral, steer and brake modes. In the neutral mode, each castor is free to swivel about its pivot, and allows the bed to be maneuvered into tight spaces, as in for example when the bed is parked at a patient care station in a ward. However, in this mode the bed is longitudinally unstable, and is difficult to maintain in straight path or to controllably turn corners during long range transportation, particularly when the bed is loaded with a patient. Often two orderlies are required to control the movement of the bed. In the steer mode, the castors are locked against swiveling, and are aligned parallel to the longitudinal dimension of the bed. In the brake mode, a brake pad in the castor is pressed against the castor wheel preventing rotation thereof.

A fifth fixed-direction auxiliary wheel, or a pair of such wheels, is sometimes mounted at or spaced from the center of gravity of the bed to improve stability of the bed during long-range transportation, and can be reversibly retracted when high maneuverability is required for parking the bed. Such arrangements are known from U.S. Pat. No. 5,987,671, U.S. Pat. No. 6,256,812, U.S. Pat. No. 5,348,326, U.S. Pat. No. 3,304,116 and WO 98/20830.

Nevertheless, such beds still require substantial efforts for controlling and propelling the same, sometimes necessitating more than one orderly for this purpose if collisions are to be avoided. Particularly when only one orderly is used for transporting a patient, the cumulative distance traveled and the effort expended in pushing the bed, during a regular working day, can result in fatigue, strains and even physical injuries to the hospital staff. Furthermore, on occasion this may result in partial loss of control of the bed, and may cause damage to equipment as well as injury to the patient being transported.

A commercially available power-driven trolley comprises a fifth wheel arrangement and is steered by a differential steering arrangement, in which the motive power to each one of two powered wheels is separately controlled.

Similar problems may be encountered in platforms in the form of wheelchairs used to transport persons in the seated position. In one application, such wheelchairs are used in hospital to transport patients; in another application, such wheelchairs are used to transport people in an aircraft terminal, and often up to an airplane. Such wheelchairs often comprise two or four castors.

### SUMMARY OF THE INVENTION

The present invention relates to a maneuverable device for transporting a load over a surface, comprising:

a platform for supporting a load to be transported;

a base comprising a plurality of castors;

at least one auxiliary wheel mounted for rotation about at least one fixed axis with respect to said base;

a power unit configured for providing motive power to said at least one auxiliary wheel;

a driving unit for steering said device, wherein the driving unit operates independently of said at least one auxiliary wheel.

The device preferably further comprises a deployment/retraction mechanism, such as for example suitable pneumatic or hydraulic jack arrangement, for selectively deploying and retracting said at least one auxiliary wheel with respect to said surface, wherein when deployed said at least one auxiliary wheel is in traction contact with said surface, and wherein when retracted said at least one auxiliary wheel is distanced away from said surface. The deployment/retraction mechanism may be controlled by means of a pedal which is actuable by a user.

The platform may be mounted to said base by means of a pair of longitudinally spaced support columns. Each one of said columns may be independently adjustable in length to enable the height and inclination of said platform to be adjusted with respect to said base. The columns are typically controllable by means of a system of foot pedals which are actuable by a user.

The power unit typically comprises an electric motor coupled to said at least one auxiliary wheel, and further comprises a suitable electrical power source operatively connected to said motor. Optionally, the driving unit is retractably mounted to said platform, and in one embodiment, the driving unit comprises a pair of longitudinally opposed and coaxial handlebars. At least one said handlebar comprises a control mechanism for controlling the speed of said at least one auxiliary wheel. The at least one controlling handlebar may be configured to maintain operative connection between said power source and said motor only when said controlling handlebar is being grasped by a user in a predetermined manner. Optionally, the controlling handlebar comprises a twist-grip control mechanism, which is configured to disconnect operative connection between said power source and said motor when said twist-grip mechanism is in a datum position, and biased to return said twist-grip mechanism to said datum position when said controlling handlebar is ungripped by a user. Additionally or alternatively, the controlling handlebar comprises a control mechanism in the form of a switch, which is configured to disconnect operative connection at least between said power source and said motor when said switch is in a datum position, said switch being biased to return to said datum position when said switch is released by a user.

The driving unit typically comprises display panel having one or more suitable indicators. These indicators may comprise at least one of: a grip indicator for indicating when appropriate that an operator is holding one or both said handlebars; a low battery indicator; an overload indicator for indicating that the carrying load of the device is overloading the motor; a forward/reverse switch to enable the direction of motion of the device to be reversed.

The castors are configured to selectively operate in any one of at least two modes, including a neutral mode and a brake mode. In one embodiment, the plurality of castors are linked one to the other such that said plurality of castors are simultaneously actuated to operate in one or the other of said at least two modes. In such a case, the plurality of castors is controllable by means of a pedal system which is actuable by a user. Optionally, the castors are configured to selectively operate in any one three modes, including a neutral mode, a steering mode and a brake mode. Further optionally, the plurality of castors are linked one to the other such that said plurality of castors are simultaneously actuated to operate in one or the other of said three two modes, and the plurality of castors may be controlled by means of a pedal system which is actuable by a user.

In another embodiment, the device further comprises a steering system for collectively steering said plurality of castors in the steering mode responsive to a controlling input from said driving unit. The steering system comprises a linkage system between said castors configured to provide each castor with a axis of rotation that crosses a common turning center for said device, wherein said axis of said auxiliary wheel also crosses said center, and wherein the position of said center relative to said device is controlled by means of said driving unit.

In one application of the device, the device is in the form of a bed for transporting a patient along a ground surface, and the bed may comprise at least one tilting portion that is pivotably mounted with respect to a remainder of said platform. In another application, the device is in the form of a chair for transporting a person in the seated position, for example in a hospital or airport environment.

Thus, according to the invention, when the device is in the powered mode, the device provides its own motive force, for level or inclined paths, and the user, such as a hospital orderly or airport attendant for example, merely has to steer the platform. This reduces the motive effort by the user to a minimum, often to zero, and helps prevent potential injuries or stress to the user, as well as harm or injury to third parties, or damage to external infrastructure or equipment in proximity to the path of the platform.

The present invention is also directed to a maneuverable device for transporting a load over a surface, comprising:

a platform for supporting a load to be transported;

a base comprising a plurality of castors;

at least one auxiliary wheel mounted for rotation about at least one fixed axis with respect to said base;

a driving unit for steering said apparatus, wherein the driving unit operates independently of said at least one auxiliary wheel

a steering mechanism for collectively steering said plurality of castors in responsive to a controlling input from said driving unit.

In such a device, the castors may be configured to selectively operate in any one three modes, including a neutral mode, a steering mode and a brake mode. Preferably, the plurality of castors are linked one to the other such that said plurality of castors are simultaneously actuated to operate in one or the other of said three two modes. The plurality of castors may be controllable by means of a pedal system which is actuable by a user.

The device may further comprise a steering system for collectively steering said plurality of castors in the steering mode responsive to a controlling input from said driving unit. The steering system may comprise a linkage system between said castors configured to provide each castor with a axis of rotation that crosses a common turning center for said device, wherein said axis of said auxiliary wheel also crosses said center, and wherein the position of said center relative to said device is controlled by means of said driving unit. In one application of the device, the device is in the form of a bed for transporting a patient along a ground surface, and the bed may comprise at least one tilting portion that is pivotably mounted with respect to a remainder of said platform.

In one application of the device, the device is in the form of a bed for transporting a patient along a ground surface, and the bed may comprise at least one tilting portion that is pivotably mounted with respect to a remainder of said platform. In another application, the device is in the form of a chair for transporting a person in the seated position, for example in a hospital or airport environment.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is an isometric view of a transportable bed according to a first embodiment of the invention.

FIG. 2 illustrates the base part of the embodiment of FIG. 1

FIG. 3 illustrates in side view the embodiment of FIG. 2 with the auxiliary wheel in the retracted position.

FIG. 4 illustrates in side view the embodiment of FIG. 2 with the auxiliary wheel in the deployed position.

FIG. 5 schematically illustrates in plan view steering operation of the embodiment of FIG. 1 using the driving unit thereof.

FIG. 6 schematically illustrates in side view a variation of the embodiment of FIG. 2 with the auxiliary wheel in the deployed position.

FIG. 7 is an isometric view of a variation of the embodiment of FIG. 1 comprising a pivoted wheeled support.

FIG. 8 schematically illustrates in plan view steering operation of the embodiment of FIG. 7 using the driving unit thereof.

FIG. 9 schematically illustrates in plan view steering operation of a second embodiment using the driving unit thereof.

FIG. 10 schematically illustrates in plan view steering operation of a variation of the embodiment of FIG. 9 comprising a support.

### DETAILED DESCRIPTION

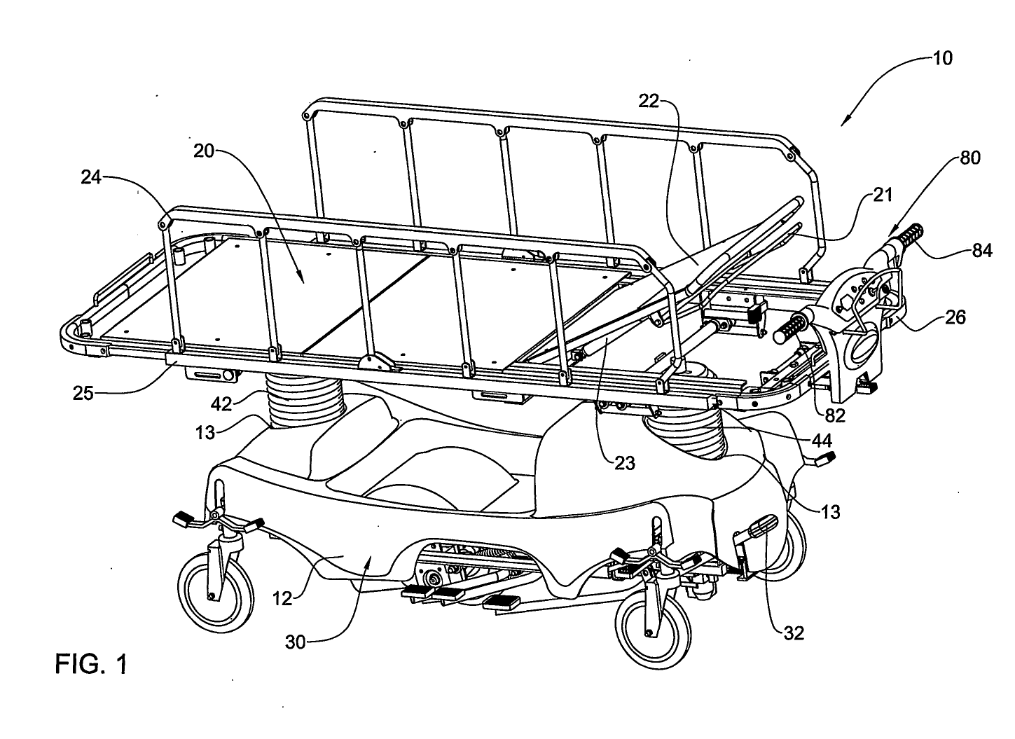

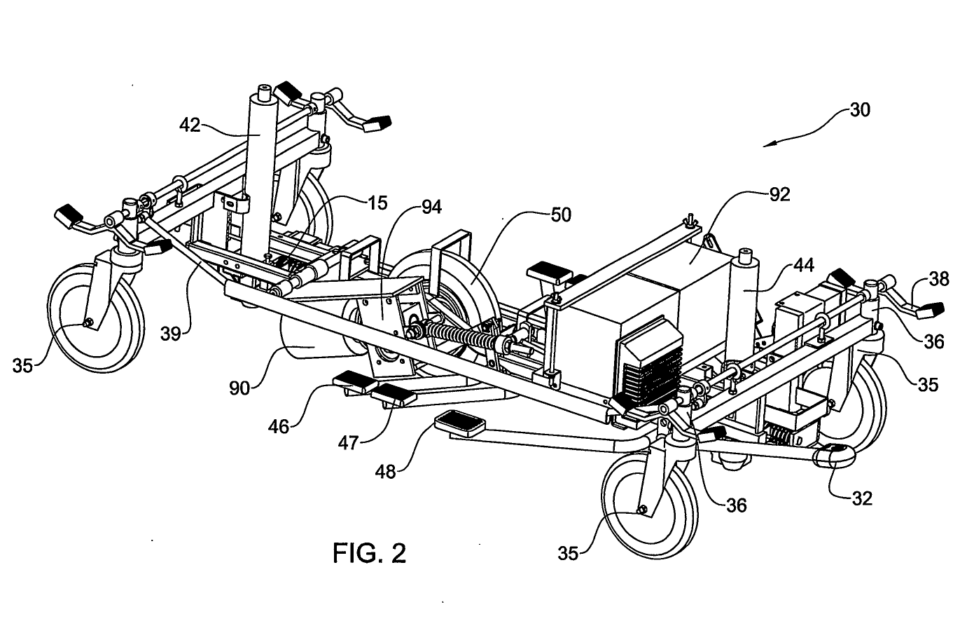

A first embodiment of the invention, illustrated in FIGS. 1 to 4, comprises a maneuverable bed, generally designated with the numeral 10, having a platform 20 mounted onto a wheeled base 30.

The platform 20 is generally adapted for accommodating a patient, which may be an adult or a child, for example, in the lying position. In other applications the bed may be adapted for accommodating an animal, for example in a veterinary's clinic. In this embodiment, the platform comprises one or more tilting portions, such as portion 22, that is pivotably mounted with respect to a remainder of said platform. Portion 22 may be selectively tilted with respect to the rest of the platform 20, enabling the patient to sit up on the bed, for example. For this purpose, the portion 22 comprises an actuation handle 21, and supporting extendible jack 23. Furthermore, the platform 20 is mounted to the base 30 via longitudinally spaced columns 42, 44, which are adjustable in height, separately or together, and thus enable the angle and separation of the platform 20 with respect to the base 30 to be controlled. For this purpose, the columns 42, 44 preferably comprise hydraulic jacks, or any other type of pneumatic, electrical, mechanical or other actuator, which may be manually operated or, preferably, power driven. The columns 42, 44 thus allow the trendelenburg or reverse trendelenburg positions to be adopted by the bed. The height of each column 42, 44 may be controlled by means of a suitable operating foot pedals 46, 47, 48 and such arrangements are known in the art. For example, pedal 48 raises both columns 42, 44, to the height required by the user. Each one of the pedals 46, 47 enables the respective columns 42, 44 to be lowered independently, allowing the platform 20 to assume any one of a range of positive or negative acute angles with respect to the horizontal. Furthermore, if both pedals 46, 47 are actuated, both columns 42, 44 are lowered together.

In other embodiments, the angle and/or spacing of the platform 20 may be fixed with respect to the base 30.

The platform 20 preferably further comprises side rails 25, mounted via retraction mechanism 24, or for example in the manner described in U.S. Pat. No. 5,17,824, the contents of which are incorporated herein in their entirety.

The wheel base 30 comprises a plurality of castors 35 mounted thereto via castor housings 36. The castor housings 36 are located typically at four corners of the base 30 typically defining a rectangle, though in other embodiments the locations of the plurality of castors may define any suitable polygon.

In this embodiment, the castors 35 are each capable of assuming any one of the two modes: neutral and brake modes. Similarly to prior art arrangements, in the neutral mode each castor 35 can freely swivel with respect to the castor housings 36, and in the brake mode the castor wheel is prevented from turning in the castor. A double pedal actuator 38 is provided for changing the operational mode of the castors between neutral and brake modes by pressing one or the other of the two pedals of the actuator 38. A linkage mechanism 39 links the pedal actuators 38 of the four castors 35, so that actuating any one of the actuators 38 changes the operating mode of all four castors 35 as required.

Further, the base 30 comprises a deployable auxiliary wheel arrangement, typically a single wheel 50, which is aligned so that its plane of rotation is fixed and parallel to the longitudinal axis 100 of the bed 10, and typically located approximately at the center of gravity of the bed 10. In other embodiments, the auxiliary wheel arrangement may comprise two or more auxiliary wheels, which may be spaced at any desired spacing one from the other, and which may be at, or offset with respect to, the center of gravity of the bed 10.

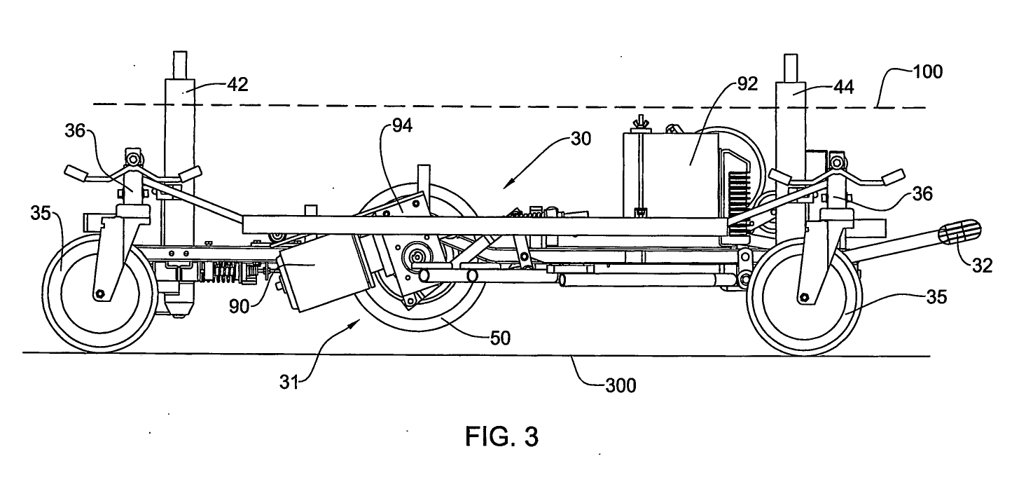

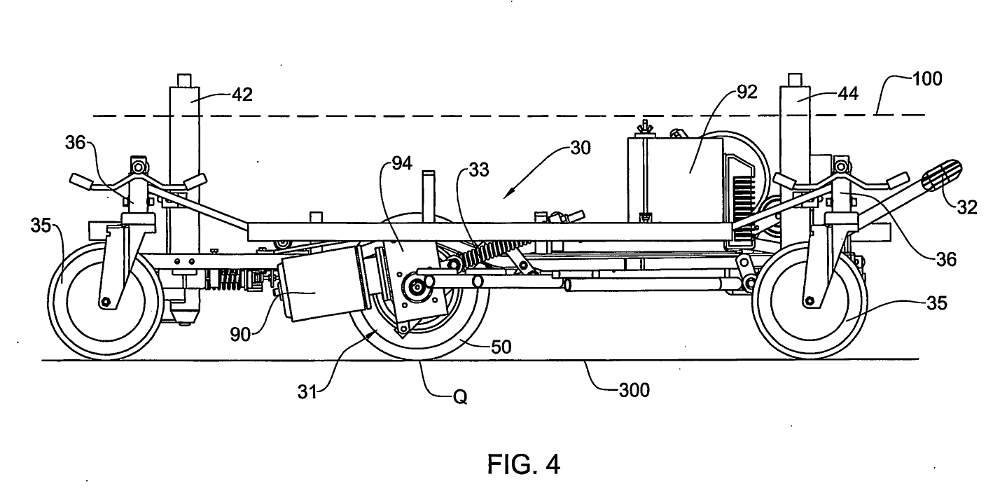

The auxiliary wheel 50 is mounted to the base 30, and comprises a suitable deployment/retraction mechanism such as to enable the wheel 50 to be reversibly moved between a retracted position and a deployed position. In the retracted position, illustrated in FIG. 3, the wheel 50 is effectively lifted away from the ground 300, and thus the base 30 is supported only by the castors 35. In such a mode of operation, particularly when the castors themselves are in neutral mode, the bed 10 can be maneuvered into any required parking space, in the traditional manner, by pushing or pulling different parts of the bed. In the deployed mode, illustrated in FIG. 4, the wheel 50 makes traction contact with the ground 300, and provides dynamic stability to the bed 10 when this is being transported from one location to another location, as described above. Thus, the base. 30 further comprises a deployment/retraction mechanism 31, which is preferably actuated by means of a foot pedal 32. Such a deployment/retraction mechanism 31 may comprise, for example, a pneumatic or hydraulic jack arrangement 33, or indeed any other suitable arrangement, for example as described in the aforementioned U.S. Pat. No. 5,987,671, U.S. Pat. No. 6,256,812, U.S. Pat. No. 5,348,326, U.S. Pat. No. 3,304,116 and WO 98/20830, and the contents of all these publications are incorporated herein in their entirety by reference thereto.

Referring to FIG. 1, the bed 10 further comprises a driving unit 80, which in the illustrated embodiment comprises a handle bar arrangement, having a pair of opposed and co-axial handlebars 82, each of which is graspable by a different one of the right hand and the left hand of the user. The driving unit 80 is mounted to the bed 10, for example to one longitudinal end of the frame 26 of platform 20, such that the axis of the handlebars 82 is parallel to the axis of rotation of the fifth wheel 50, and the handlebars 82 are disposed above the platform 20. Preferably, the driving unit 80 is pivotably mounted or otherwise retractable with respect to the platform 20, so that it can be moved out of the way when the driving unit 80 is not being used, for example when the bed 10 is parked in a ward. In the deployed position of the driving unit 80 illustrated in FIG. 1, the handlebars 82 are at a suitable height for allowing the user to steer the bed in an easy manner, as will be further described herein.

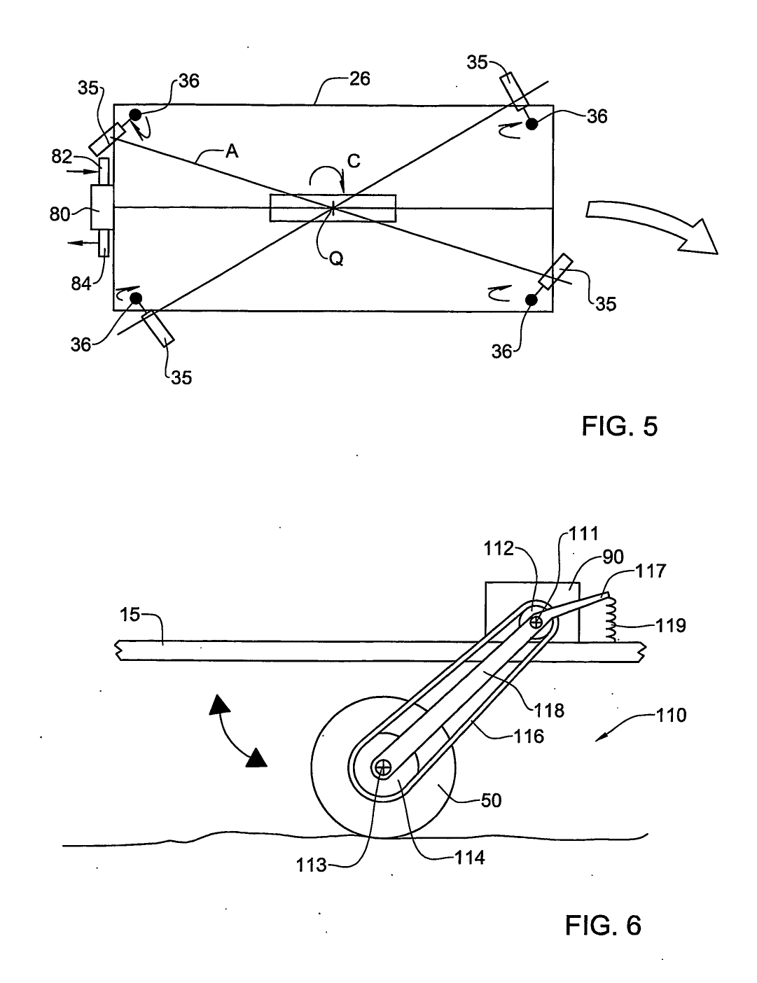

Referring to FIG. 5, when the user pulls one handlebar and pushes the other handlebar, a coupling motion C is induced to the bed 10 via the frame 26, such as to turn the bed about a pivoting point at the contact point Q of the fifth wheel 50 and the ground. At the same time, the castors 35, which are in neutral mode, automatically attempt to align their rotational axes A by swiveling with respect to the housings 36, so that these axes A pass through point Q, which is the center of the rotation. Thus, the contact point Q is effectively used as a pivot when the user wishes to change the direction of motion of the bed 10. In this embodiment, the wheel 50 is at or near the center of gravity of the bed 10, and the driving unit 80 is centrally located on the axis 100 thereof.

The more the driving unit 80 is turned (together with the bed), the more the bed is pivoted, and the smaller the turning radius becomes if the bed is also being moved in a longitudinal direction at the same time as it is being pivoted, i.e., the center of the effective turning circle of the bed is moved closer to the bed 10. Thus, by turning the driving unit 80 in one direction or the other, and by controlling the degree of turning, the bed 10 is maneuvered with respect to any desired center of rotation for the bed, enabling the direction of motion of the bed 10 to be controlled by means of the driving unit.

In other embodiments, the driving unit may be mounted to the base 30 rather than the platform 20, in a fixed or retractable manner.

In this embodiment, the auxiliary wheel 50 is powered by a suitable motor 90, which is mounted to the base 30 via a chassis 15. The motor 90 is typically connected to the wheel 50 via a suitable gearbox arrangement 94, or via a direct transmission, or any suitable arrangement. For example, and referring to FIG. 6, the motor 90 is connected to wheel 50 via a drive belt arrangement 110 comprising a driver wheel 112 kinematically connected to the driveshaft of motor 90, and a driven wheel 114 rigidly connected to the wheel 50, wherein the driver wheel 112 is kinematically connected to the driven wheel 114 via a chain or belt 116. The relative diameters of the wheels 112, 114 determines the torque and speed of the wheel 50 relative to the motor 90. In the arrangement of FIG. 6, the wheels 112, 114 are both independently mounted for rotation on a strut 118 about pivots 111 and 113, respectively. The strut 118 is additionally pivotable via pivot 111 at least about a suitable arch enabling the wheel 50 to be selectively deployed and retracted with respect to the ground surface. The strut 118 preferably comprises a bracket 117 at an end thereof opposed to the end comprising said wheel 50, and a spring 119 is mounted between the bracket 117 and the chassis 15 of the device which facilitates the deployment/retraction operation of the wheel 50.

The motor 90 is typically a DC electrical motor, but any other suitable motor or engine may be used. A power source, such as one or a plurality of rechargeable batteries 92, is also mounted to the base 30, and electrically connected to the motor 90, to provide power thereto. Operation of the motor 90 is via the driving unit 80. Preferably, the driving unit 80 comprises an on/off switch that switches off current between the batteries 92 and the motor 90 in the “off” position, but in the “on” position places the connection in a standby mode. Preferably, the on/off switch is operated by means of a removable key, which provides some security against unauthorized use of the bed 10 in powered mode. Further, one of the handlebars 82 is preferably configured as an accelerator arrangement, such that the more the handlebar is rotated about its longitudinal axis relative to the driving unit 80, the faster the auxiliary wheel 50 turns, and thus the greater the velocity of the bed 10. For example, the accelerator handlebar 82 may comprise a hand-grasping sleeve that is rotatable with respect to the main body of the handlebar 82, and comprises a capacitor arrangement operatively connected to the on/off switch, the motor 90 and the batteries 92. Thus, as the sleeve is rotated, more current is provided to the motor 90, which thus turns faster. Alternatively, the sleeve may comprise a sensor arrangement that senses the rotational angle of the sleeve, and sends an appropriate signal to a suitable microprocessor, which in turn sends an appropriate control signal to the motor 90 to control operation thereof. As a safety measure, the sleeve may be spring loaded and biased to return the sleeve to the original position when not being actively turned by an operator of the bed 10. In the original position of the sleeve, current is cut off from the motor 90, and the bed 10 no longer moves in a powered manner. Thus, unless the operator is actively grasping the controlling handlebar 82, and turning the sleeve, the bed 10 cannot be operated in a powered mode.

In particular, at least one of the handlebars 82 further comprises another on-off switch that is spring-loaded so that in the unbiased position is in the off-position. Thus, the switch must be grasped in the “on” position continuously by the user in order to enable the bed power supply to be connected to the motor. Thus, if for any reason the user ceases to grasp the switch, for example by removing his/her hand from the handlebar, current is immediately cut from the motor, which then stops running, bringing the bed to a complete electrical shutdown. Advantageously, the motor comprises a lockup mechanism that locks the auxiliary wheel in the braked position as soon as current is stopped by means of the aforesaid switch.

Such an on-off switch is an important safety feature, and may be used instead of or in addition to the spring loaded accelerator sleeve arrangement described above. When used instead of the sleeve, the sleeve is thus effectively replaced with a switch that maintains the operative connection between the batteries and the motor so long as the user is pressing the switch, and biased to cut off the connection between the batteries and the motor when the user ungrips the switch. Another switch arrangement may be used to set the speed of the bed.

Optionally, the bed 10 may be used in a partially powered mode, wherein the motor 90 provides a part of the motive force, and the user provides the rest of the motive force required to move the bed 10.

In general, though, in the powered mode, the bed 10 provides its own motive force, for level or inclined paths, and the user, such as a hospital orderly, merely has to steer the bed 10. This reduces the motive effort by the user to a minimum, often to zero, and helps prevent potential injuries or stress to the user, as well as harm or injury to other staff or patients, or damage to hospital infrastructure or equipment.

As is clear for the aforegoing description, the driving unit 80 facilitates steering of the bed 10 and enables a single user to steer the bed 10, even when this is operating in unpowered mode, but with the auxiliary wheel 50 engaged on the ground, and thus the driving unit 80 is not coupled to the motor or to the auxiliary wheel 50. Thus, the driving unit 80 operates independently of auxiliary wheel 50 or the motor 90, i.e., the driving unit 80 enables the bed 10 to be steered independently of the wheel 50 or the motor 90.

This arrangement thus reduces operating costs by reducing the number of personnel required for transporting patients or equipment, and reduces the risk of collision damage to the bed 10 itself, or indeed to other equipment or structures, such as for example doorways.

The base 30 preferably further comprises a fairing 12, illustrated in FIG. 1, which protects the elements of the base, such as for example the motor 90 and batteries 92, from mechanical knocks and from splashes or spillages from above. The fairing 12 comprises suitable apertures 13 to allow the columns 42, 44 to extend therethrough, enabling the platform 20 to be mounted thereto.

Optionally, the bed 10 further comprises a foot support (not shown) in the form of an auxiliary wheeled base, which is pivotably mounted to the base 30 via a vertical hinge arrangement or a universal joint arrangement, for example. The foot support is typically in the form of a platform or stirrup on which one or both feet of the operator can rest, so that the operator may also be effectively carried by the motive force provided by the bed 10 when this is operated in powered mode. In other embodiments, the support may be retractable, or foldable, or detachable, so that it is out of the way when the bed 10 is not in powered mode, or when the operator does not wish to be supported and carried by the bed 10. The support is comprised at the same end of the bed as the control unit 80, to facilitate operation thereof.

In yet other embodiments, the bed may comprise a wheeled stool, seat or similar support (not shown) pivotably connected to the bed for enabling an operator to sit on the support when the bed is operated in powered mode. Optionally, such a seating arrangement may be retractable, or foldable, or detachable, so that it is out of the way when the bed is not in powered mode, or when the operator does not wish to be supported and carried by the motive power provided by the bed.

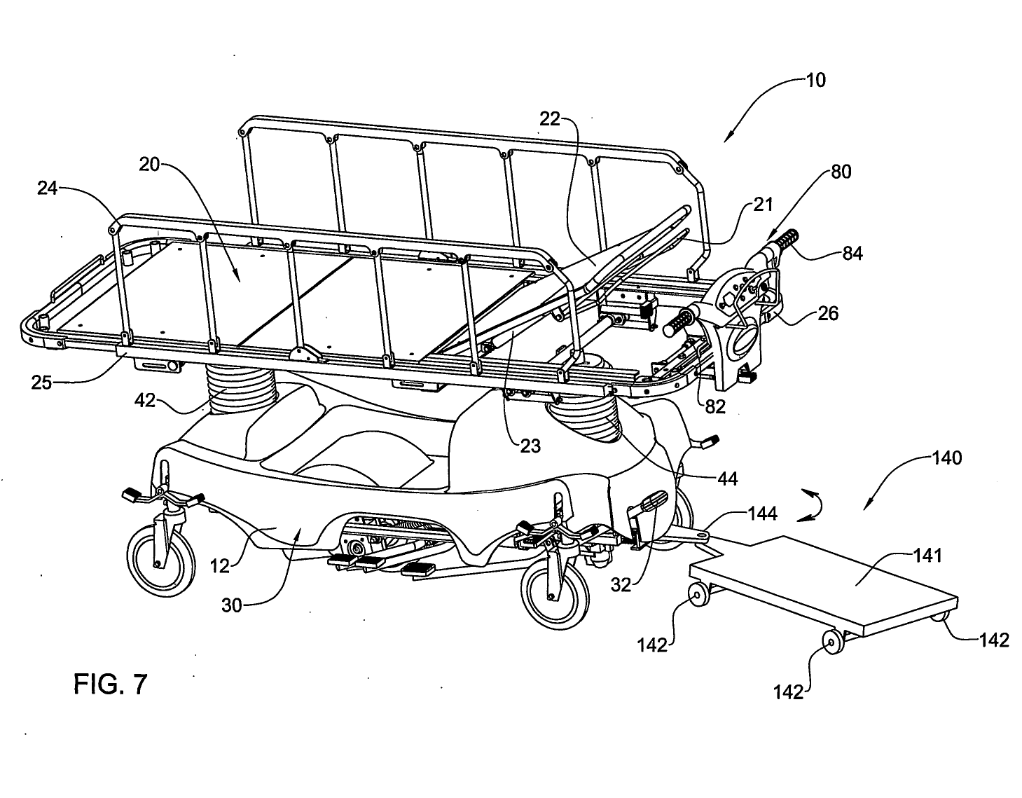

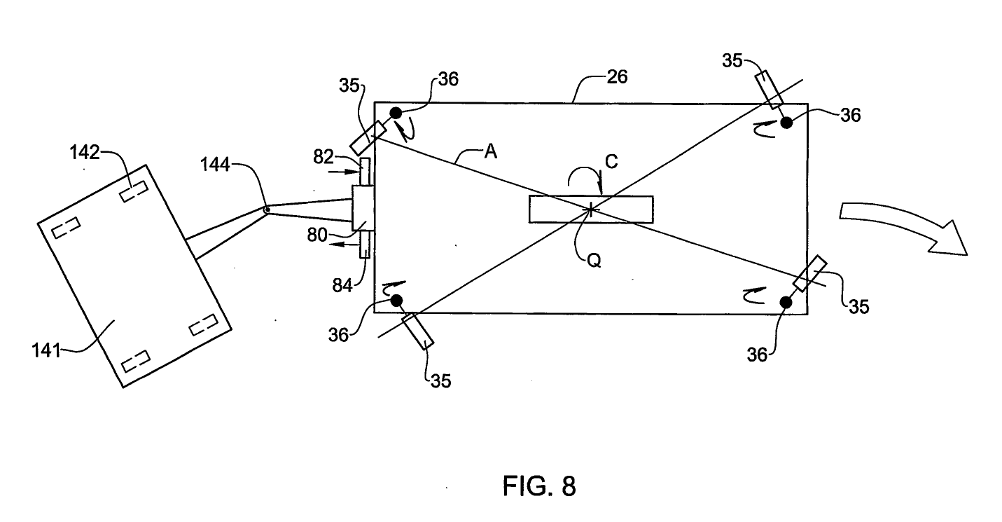

In particular and referring to FIGS. 7 and 8, the bed 10 optionally comprises a driver support 140 in the form of a platform 141 which is pivotably mounted to the bed 10 via a vertical pivot 144, or by a universal joint, or indeed any suitable arrangement that enables the platform 140 to swing with respect to the bed 10. The platform 140 comprises a plurality of wheels 142 in contact with the ground at least when in use. The wheels 142 may be mounted onto fixed or pivoted axles, or castors, which are suitably mounted to the platform 140. The platform 140 may be adapted for supporting a user that is controlling the bed 10. In one embodiment of the platform 140, the user may be in a standing position, and the platform may be close to the ground, the wheels 142 being of relatively small diameter. The size of the platform may be such as to allow the users two feet to be supported thereon. Alternatively, the platform 140 may assume the form of a single or a pair of roller-skates or of a skateboard, suitably pivoted to the bed 10. In another embodiment, the user is in a sitting position, and thus the platform comprises a seat portion elevated from the ground. In each case, the platform 140 is towed behind the bed 10, and at the same time allows the user to pivot the bed 10 about the wheel 50 while the bed is moving under the motive power provided by the motor 90, by virtue of the platform 140 being in independent contact with the ground. The platform 140 may be adapted for folding or retracting into the bed 10 when not in use, or may be disconnected from the bed 10 via the pivot 144.

The driving unit 80 preferably further comprises status indicators, for example, an sleeve grip indicator 81, which indicates when appropriate that the operator is holding one or both handlebars 82, low battery indicator 83, overload indicator 84, which indicates that the carrying load of the bed is overloading the motor 90, forward/reverse switch to enable the direction of motion to be reversed.

In other embodiments, the auxiliary wheel 50 is not powered, and thus the bed is moved by manual motive power provided by the operator. In such a case, the operator typically moves the bed 10 by pushing or pulling the same, depending on the desired direction, via the driving unit 80, which enables the operator to maneuver the bed in a simple and accurate manner. Of course, in such embodiments, the control unit does not require indicators such as the low battery indicator described above, for example.

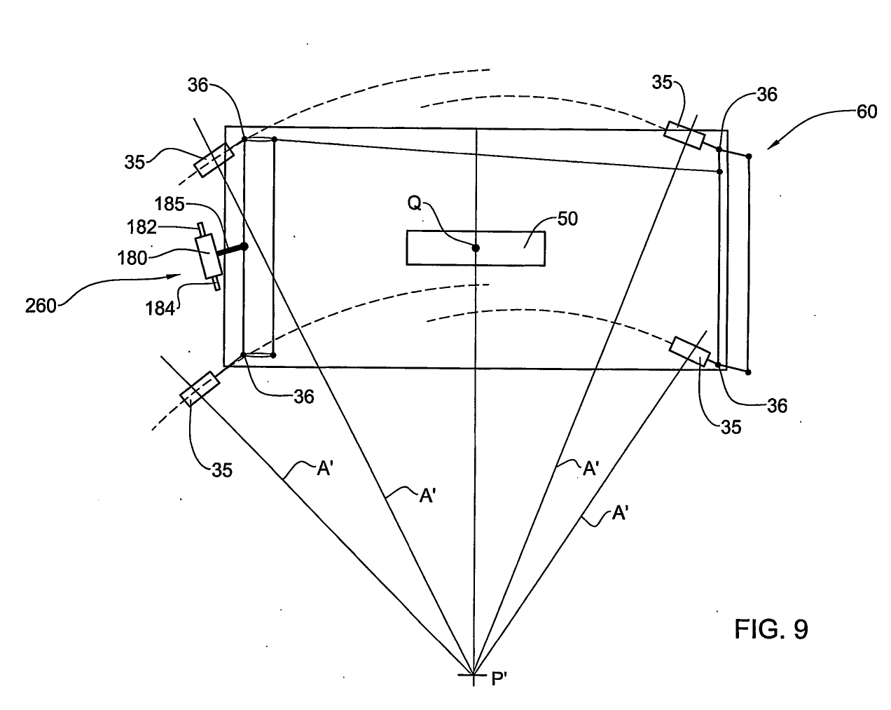

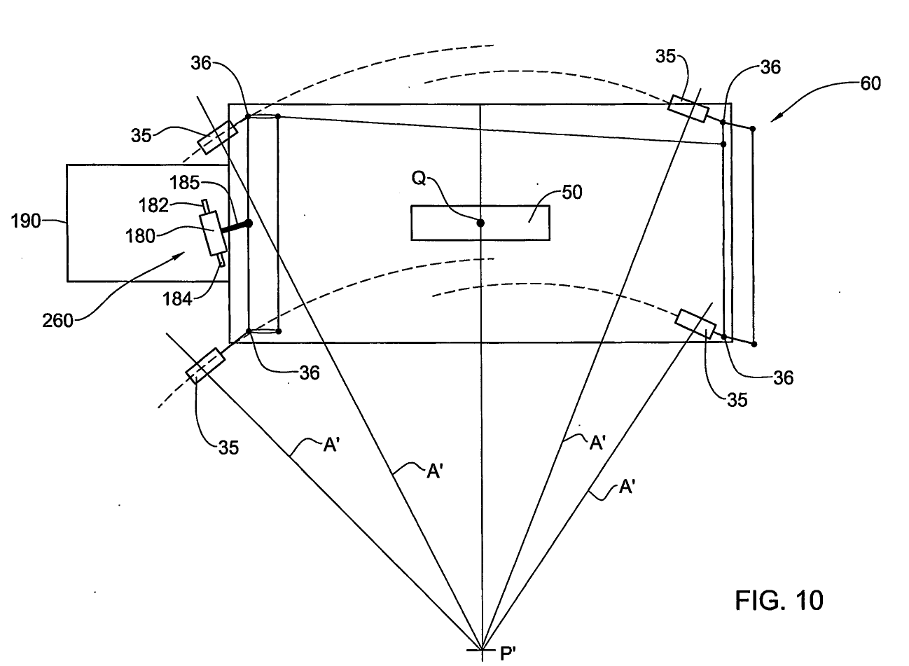

A second embodiment of the invention, illustrated in FIG. 9, comprises all the elements and features as described with respect to the first embodiment, mutatis mutandis, with the following differences.

In the second embodiment, the castors 35 are each capable of assuming any one of the three modes: neutral, steer and brake modes. Similarly to prior art arrangements, in the neutral mode each castor 35 can freely swivel with respect to the castor housings 36, and in the brake mode the castor wheel is prevented from turning in the castor. However, in the steering mode, each castor 35 is locked in position with respect to a castor housing 36. Each castor housing 36 is pivotably mounted with respect to the base 30, and can assume any angular position about an axis substantially parallel to the swivel axis of the castor.

A steering mechanism 60 is provided, which in this embodiment comprises a link arrangement linking the castor housings 36 to one another, such that on the one hand, when the castors 35 are in steering mode, the rotational axes A′ of the wheels of the castors 35 are parallel one to the other, and also parallel to the auxiliary wheel 50, enabling the bed 10 to move in a rectilinear direction. On the other hand, the steering mechanism 60 also aligns the castors 35 such that these axes A′ are constrained to all pass through a point P′, and the rotational axis of the auxiliary wheel 50 also passes through P′. Point P′ represents a centre of rotation for the bed 10, so that the bed 10 can be controllably be steered around corners and the like, at least for a range of mean turning radii R compatible with the turning requirements for a hospital-type environment.

The mechanism 60 is operatively connected to a driving unit 180, which may be similar to the driving unit 80 of the first embodiment, mutatis mutandis, with the following differences. As in the first embodiment, the driving unit 180 of the second embodiment comprises a handle bar arrangement, having a pair of opposed handlebars 182, each of which is graspable by a different one of the right hand and the left hand of the user. The driving unit 180 is pivotably mounted to the bed 10 about an axis 260, which is typically oriented vertically with respect to the bed 10, but may be oriented in any other suitable position. The driving unit 180 is connected to the mechanism 60, typically by a system of linkages 185. The steering mechanism 60 is responsive to the driving unit 180 such that when the user pulls one handlebar and pushes the other handlebar such as to turn the driving mechanism about axis 260, these linkages are moved in a prescribed manner, and in turn adjust the relative positions of the castor housings 36 to align the axes A′ of the corresponding castors 35 with a point P. The more the driving unit 80 is turned, the smaller the turning radius becomes, i.e., point P is moved closer to the bed 10. Thus, by turning the driving unit 180 in one direction or the other, and by controlling the degree of turning, the castors 35 can be aligned with any desired center of rotation P′, enabling the direction of motion of the bed 10 to be precisely controlled.

Alternatively, the driving unit 180 may be configured to turn in a similar manner to a handlebar of a bicycle or to a steering wheel of a motor vehicle, and suitably connected to the steering mechanism 60 to control the relative angular dispositions of the castors 35 as described above, mutatis mutandis.

Thus, the mechanism 60 can comprise any suitable mechanical link arrangement that provides the motion described above, and many different configurations are possible.

Alternatively, the steering mechanism 60 comprises, instead of said linkage arrangement, a motor unit operatively connected to each castor wheel housing 36, to independently control the angular disposition of the castor 35 with respect to the base 30. In such an arrangement, a suitable sensor senses the direction and angular displacement of the driving unit 180, and a suitable microprocessor, operatively connected to the sensor and to the motor units, calculates the angular rotation required for each housing 36, such as to intersect the axes A′ with a suitable point P′, providing suitable control signals to the motors to effect the desired rotations.

In the second embodiment, the auxiliary wheel 50 may have a relatively wide tread, or may be replaced with a plurality of auxiliary wheels.

In yet other variations of the second embodiment, the bed may comprise a stool, seat or similar support, for example support platform 190 illustrated in FIG. 10, connected to the bed for enabling an operator to sit on the support when the bed is operated in powered mode. Optionally, such a seating arrangement may be retractable, or foldable, or detachable, so that it is out of the way when the bed is not in powered mode, or when the operator does not wish to be supported and carried by the motive power provided by the bed. Optionally, such a support may comprise wheels in contact with the ground when in use. Further optionally, the support may be pivotably connected to the bed, for example in a similar manner to that described for the first embodiment, mutatis mutandis.

While the present invention has been described in the context of a bed, in particular a hospital bed, the present invention is also directed, mutatis mutandis, to any other maneuverable platform, such as for example a trolley or medical supply carrier, or a chair for transporting a person or patient in the nominally sitting position, among other applications.

While there has been shown and disclosed exemplary embodiments in accordance with the invention, it will be appreciated that many changes may be made therein without departing from the spirit of the invention.

It should be noted that the word “comprising” as used throughout the appended claims is to be interpreted to mean “including but not limited to”.

1. A maneuverable device for transporting a load over a surface, comprising:
a platform for supporting a load to be transported;
a base comprising a plurality of castors;
at least one auxiliary wheel mounted for rotation about at least one fixed axis with respect to said base;
a power unit configured for providing motive power to said at least one auxiliary wheel;
a driving unit for steering said device, wherein the driving unit operates independently of said at least one auxiliary wheel.

2. Device according to claim 1, comprising a deployment/retraction mechanism for selectively deploying and retracting said at least one auxiliary wheel with respect to said surface, wherein when deployed said at least one auxiliary wheel is in traction contact with said surface, and wherein when retracted said at least one auxiliary wheel is distanced away from said surface.

3-4. (canceled)

5. Device according to claim 1, wherein said platform is mounted to said base by means of a pair of longitudinally spaced support columns.

6-8. (canceled)

9. Device according to claim 1, wherein said driving unit is retractably mounted to said platform.

10-16. (canceled)

17. Device according to claim 1, wherein said castors are configured to selectively operate in any one of at least two modes, including a neutral mode and a brake mode.

18-28. (canceled)

29. Device according to claim 1, wherein said device is in the form of a bed for transporting a patient along a ground surface.

30. (canceled)

31. Device according to claim 1, wherein said device is in the form of a chair for transporting a person along a ground surface.

32. A maneuverable device for transporting a load over a surface, comprising:
a platform for supporting a load to be transported;
a base comprising a plurality of castors;
at least one auxiliary wheel mounted for rotation about at least one fixed axis with respect to said base;
a driving unit for steering said apparatus, wherein the driving unit operates independently of said at least one auxiliary wheel
a steering mechanism for collectively steering said plurality of castors in responsive to a controlling input from said driving unit.

33. Device according to claim 32, wherein said castors are configured to selectively operate in any one three modes, including a neutral mode, a steering mode and a brake mode.

34-35. (canceled)

36. Device according to claim 32, further comprising a steering system for collectively steering said plurality of castors in the steering mode responsive to a controlling input from said driving unit.

37-39. (canceled)

40. Device according to claim 32, wherein said device is in the form of a bed for transporting a patient along a ground surface,

41. (canceled)

42. Device according to claim 32, wherein said device is in the form of a chair for transporting a person along a ground surface.
